(19) United States
(12) Patent Application Publication
(10) Pub. No.: US 2002/0030582 A1
(43) Pub. Date: Mar. 14, 2002

(54) Integrating biometric devices in time and attendance applications

(76) Inventors: Mark Depp, Fitchburg, WI (US); Martin J. Janiak, Middleton, MA (US); Greg Krueger, Jefferson, WI (US); Matthew Humphreys, Madison, WI (US); Steve Schmalz, Severna Park, MD (US); Dan Piorkowski, Madison, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/865,884

(22) Filed: May 25, 2001

Related U.S. Application Data
(60) Provisional application No. 60/207,648, filed on May 26, 2000.

(51) Int. Cl. H04Q 1/00; G06K 9/00; G05B 23/00; G05B 19/00; G08C 19/00; G08B 29/00

(52) U.S. Cl. 340/5.53; 340/5.83

(57) ABSTRACT

A biometric network for use in time and attendance applications is disclosed. The system includes at least one biometric device which is capable of identifying a user and generating data related to the user. The biometric device compares live biometric data, for example, fingerprint data, with stored biometric data, such as on an optical data card, memory card, smart card, or other biometric storage device. The invention includes a central data center which communicates with the biometric devices and receives the generated data transmitted from the biometric devices. The devices may be connected to the central data center via serial connection, wireless connection, modem, ethernet or the Internet. The generated data may relate to the attendance of the user at a particular location, the timing of particular events, such as entrance and exiting time, check-in times, or other time-stamp requirements. The biometric-verified data is included in reports generated from the time and attendance data from the biometric devices, in formats useful to the user of the application. The system provides a time and attendance application that includes a biometric solution to provide additional security and more accurate records.

### CROSS-REFERENCE TO RELATED APPLICATION

This application claims the benefit of U.S. Provisional Application No. 60/207,648 filed May 26, 2000.

### BACKGROUND OF THE INVENTION

The present invention relates generally to biometrics and biometric solutions, and more particularly to a biometric solution that uses biometric devices in time and attendance applications. The use of biometrics in the applications serves to create more accurate time stamps and individual identifications. The result is that it can be determined precisely when and if an individual is at a desired location.

The field of biometrics, or the measuring of a physical characteristic used to recognize the identity or verify the claimed identity of an individual, has emerged as an increasingly reliable methodology for verification (one-to-one) and identification (one-to-many) of individuals. Biometrics has become a very powerful tool in the solving of problems associated with requiring positive identification of individuals.

Live capture biometrics, which is the process of capturing a biometric sample by an interaction between an end user and a biometric system, has been found as an effective way to identify individuals. In many applications, generally known as time and attendance applications, it is oftentimes desirable to be able to track the time-in and time-out, the time of passing a particular location, as well as recording the attendance of a particular individual. It has been found that more secure and accurate time and attendance records may be developed by integrating biometric devices in time and attendance applications to provide a total time and attendance solution. The addition of these devices improves attendance accuracy and combats potential abuses that may occur including “punching in” for another employee, which results in inaccurate timesheets, payroll records, and attendance data. Moreover, the improvements in biometric devices have brought progress in performance, access times, accuracy, processing speeds and adaptability, all at lower costs. These improvements allow the potential for biometric devices to be brought into settings and environments where traditional time clocks may have been used, or where no time and attendance device was used before.

However, there exists a need for implementation of biometric solutions to time and attendance applications, particularly in new environments where biometrics has not previously been utilized. Therefore, there exists a need to provide a flexible network that may utilize various biometric authentication devices in a variety of configurations, such that biometric verified time and attendance transaction history may be collected and stored to provide the data for application reports specific to the time and attendance solution.

### SUMMARY OF THE INVENTION

The present invention provides a biometric network overcomes the aforementioned problems, and provides a biometric network that may be used as part of a time and attendance solution.

In one aspect of the invention, a biometric system is disclosed that includes at least one biometric device that is capable of biometrically identifying a user and generating data related to the user. A central data center is in communication with the biometric device for receiving the generated data. The generated data relates to time and attendance information with respect to the user.

In another aspect of the invention, a biometric network for use in time and attendance applications includes at least one biometric device that compares live biometric data with stored biometric data to generate time and attendance data. A central data center is in communication with the device. The biometric device includes software programmed into the device and that is operational with the central data center to facilitate communication between the biometric device and the central data center.

In another aspect of the invention, a method of monitoring time and attendance of a user is disclosed, and includes providing a plurality of biometric devices, each device at a particular location, and biometrically identifying a user. The method includes generating data relating to the user, receiving data from the biometric devices, and processing the data. The data preferably includes information related to the attendance of the user at the particular location during the identifying step. The data also may include information related to a time stamp of when the identifying of the user occurs at the particular location. In a preferred embodiment, the method includes generating a report using the data relating to the user. The biometrically identifying step preferably includes comparing stored biometric data to live biometric data. The receiving of data from the biometric devices may occur periodically or in real time.

Various other features, objects and advantages of the present invention will be made apparent from the following detailed description and the drawings.

### BRIEF DESCRIPTION OF THE DRAWINGS

The drawings illustrate one mode presently contemplated for carrying out the invention. In the drawings:

FIG. 1 is a block diagram illustrating an example of a biometric time and attendance solution network in accordance with one aspect of the present invention;

FIG. 2 is a schematic illustrating modules associated with the central data center in accordance with the present invention;

FIG. 3 is a schematic illustrating one possible application of the present invention in an educational setting;

FIG. 4 is a schematic illustrating a related application of the present invention;

FIG. 5 is a schematic illustrating a related application of the present invention;

FIG. 6 is a schematic illustrating a network of classrooms in accordance with one aspect of the invention;

FIG. 7 is a schematic illustrating another application of the present invention; and

FIG. 8 is an illustration of a sample report which may be generated as part of the present invention; and

FIG. 9 is an illustration of a sample report which may be generated as part of the present invention.

### DETAILED DESCRIPTION OF THE PREFERRED EMBODIMENT

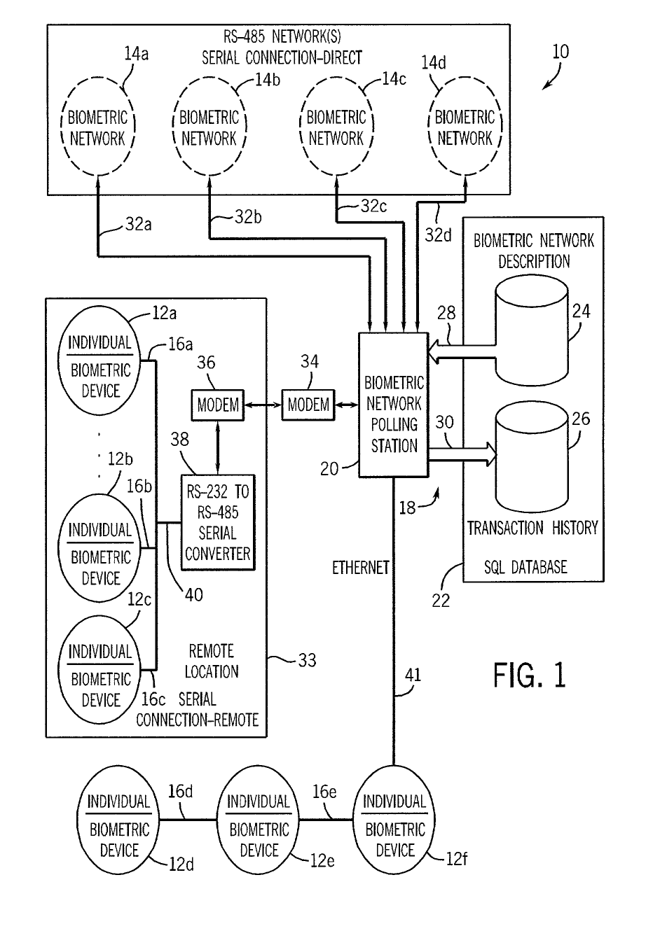

Referring now to FIG. 1, a biometric system in accordance with the present invention is disclosed generally by the numeral 10. System 10, it is contemplated, may be used as part of any desired time/attendance application to provide biometrics, such as fingerprint verification, to achieve a biometrically enhanced time and attendance solution. System 10 includes biometric devices 12a-f. The biometric devices 12a-f may be any biometric device that is capable of comparing live biometric data, such as a fingerprint from a user, to stored biometric data. Any live capture to stored biometric comparison device is contemplated as being within the scope of the present invention. Specifically, the devices may include fingerprint biometric devices, hand geometry, iris scanning, face recognition and voice recognition biometric devices. These devices may be incorporated into readers, personal digital assistants, wireless phones, laptop computers, time clocks, or any other device incorporating biometric capabilities that may be useful in time and attendance applications. Such stored biometric data may be on a chip in a memory card or smart card, both insertable or wireless. It can also be in optical form, such as an optical barcode on an optical card. Other storage tokens may be used and are contemplated, such as buttons, keyring tabs, or any other portable storage device or card. Tokens are generalized data storage devices that are personalized to the token holder.

The biometric devices may be connected together to form biometric networks as shown by 14a-d. The connections between individual devices are shown by example through connection branches 16a-e. It is understood for purposes of the present invention that the biometric devices may be connected to as many other devices as are necessary for a particular application, and may include combinations of different types of biometric devices, and in various network configurations. Some applications may only require a single biometric device. Other applications may use hundreds or thousands. The biometric network may exist in the same building, or in entirely different cities. The present invention should be seen as a flexible module, for it is the modularity of the biometric devices and ability to add biometric devices to existing networks that allows for customized biometric device networks.

Biometric devices 12a-f, as well as any biometric networks 14a-d, are also connected to a central data center 18. Central data center 18 includes a biometric network polling station 20 as well as database 22, which is the repository for the network informational data and the collected data. Database 20 includes data stores such as biometric network description data store 24 and transaction history data store 26. Data stores 24 and 26 are connected to polling station 20 to both receive information, as by connection 28, and to deliver information, as by connection 30, although any necessary information transfers may occur in any direction.

The present invention contemplates any type of connection between the biometric devices and the central data center 18. Several of these connections are shown together for ease of understanding, but it is understood that other types of connections may be made in varying combinations including one or all of the connection methods disclosed. One of the connection schemes is to directly connect the biometric devices or biometric networks to the polling station of central data center 18, as by serial connections 32a-d, to connect biometric networks 14a-d to polling station 20. The direct serial connection may be used with an RS-485 network, for example, with each network having a direct wired connection to polling station 20, and therefore data center 18.

Another type of connection contemplated by the present invention includes a connection to a remote location 33, where the connection occurs through a wired or wireless modem connection. A modem 34 is connected to the polling station 20, which transmits and receives data to and from modem 36 at the remote location 33. Other connection equipment may be used, such as any necessary converters 38, for example an RS-232 to RS-485 serial converter, in order to make the proper connections 40 between the biometric devices 12a-12c and the central data center 18.

Another type of connection contemplated by the present invention includes a connection to each biometric device 12d-12f via an Ethernet connection 41, where each biometric unit has an address to specify to the polling station which biometric device 12d-12f it is desired to contact. Although not specifically shown, this connection may also be made, if desired, through an internet connection to contact each biometric device via the world wide web.

In operation, the biometric devices 12a-12f and biometric networks 14a-d, will collect user data on time and attendance based upon the individual device usage. The time and attendance data is then stored within each unit, and when polled by polling station 20, will release the time and attendance data to the polling station 20. Polling periods may vary, and it may be desirable to poll every hour, once a day, once a week, or monthly. It is also possible if desired to obtain real-time time and attendance data. The biometric verification process makes the time and attendance data more accurate by being able to verify that an individual did pass a particular location, enter or exit a particular location, check-in or check out, punch in or punch out. Moreover, the addition of biometrics to the network assures that the actual individual who has had a successful comparison of live to stored biometric data is the individual being identified by the biometric devices for the particular time and attendance application.

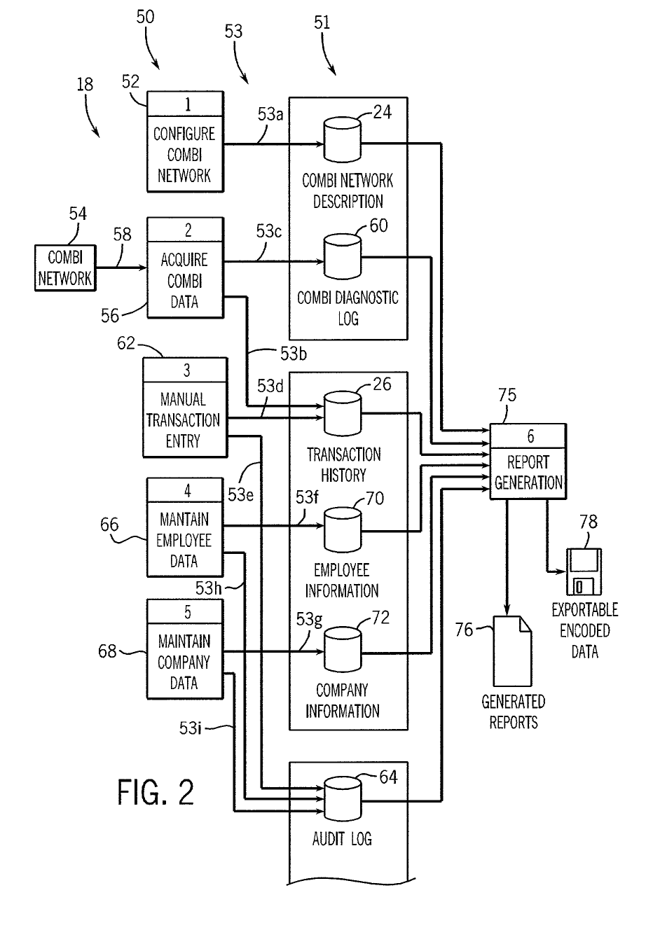

Referring now to FIG. 2, a schematic illustrating exemplary components of the central data center 18 of FIG. 1. It is recognized that the embodiment shown is representative of a particular solution, and customization, including the addition of and elimination of particular databases, is contemplated to be within the scope of the present invention. Specific databases, shown generally by 50, illustrate various functionalities of database 18 and the relationships to data stores 51, as connected by data lines 53 generally. For example, the biometric network configuration information is contained within database 52. Configuration data is sent to and from Biometric Network Description data store 24 across data line 53a. The information in this data store may include ethernet addresses, polling times, phone numbers to call, passwords, calling card numbers, or any other information to allow the central data center to “talk” to the individual biometric devices. The time and attendance data obtained by the polling of the biometric network 54 is sent to Biometric Data Acquisition database 56 through connection 58, which may be direct serial, modem or Ethernet connections as described with respect to FIG. 1. This data is transmitted to Transaction History data store 26 across data line 53b keep a record of each event at the biometric devices. The time and attendance data is also sent across data line 53c to a Biometric Device Diagnostic Log data store 60 across data line 53c to keep a record of the diagnostic information related to each biometric device. A Manual Transaction Entry database 62 is used to store data relating to manual (as opposed to biometric or electronic) entering of time and attendance data into the biometric devices. This database is used primarily when stored biometric data cards may be lost or other circumstances that make the biometric comparison unavailable. The manually entered transaction data is sent from Manual Transaction Entry database 62 to Transaction History data store 26 across data line 53d, as well as across data line 53e to an Audit Log data store 64, which tracks changes in the default biometric verification process and data. Because enrollment and other activities may take place at the biometric devices, as well as employee and company information changes, it is foreseeable that employee data and company data changes would need to be recorded, for example, when a promotion takes place. Therefore, an Employee Data Maintenance database 66 and Company Data Maintenance database 68 send changes in their respective databases to Employee Information data store 70 and Company Information data store 72, respectively, across data lines 53f and 53g. Again, any changes to databases 70 and 72 are sent to Audit Log data store 64, across data lines 53h and 53i. An important advantage of the present invention is the ability to generate more accurate information on the time and attendance of the users. Therefore, each of the data stores 24, 26, 60, 64 70, 72 are used to supply information to a Report Generation database 75, from which reports 76 may be generated and encoded data, if desired, may be stored and exported 78.

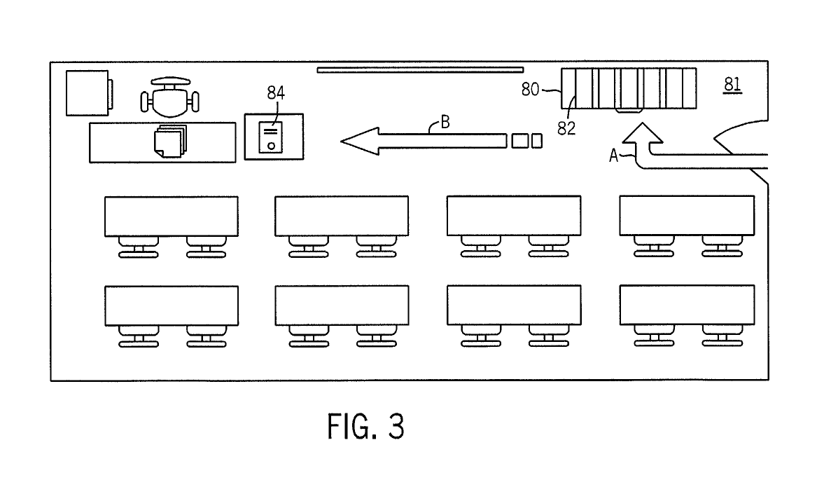

Referring now to FIG. 3, an example of a time and attendance application of the present invention is shown in a representative classroom environment 81. It is contemplated that the system may be used by many people involved in a classroom environment including parents, therapists or school-related personnel. In this application, the teacher or instructor arrives A at the classroom and approaches storage area 80, which houses all of the biometric data storage devices or tokens 82. Again, the stored biometric data may be on a chip in a memory card or smart card, both insertable or wireless. It can also be in optical form, such as an optical barcode on an optical card. Other storage tokens may be used and are contemplated, such as buttons, keyring tabs, or any other portable storage device or card. The teacher then removes the card or token 82 having the stored biometric data of that teacher from the storage area 80. In an alternate scheme, the teacher may bring the card or token and not necessarily have to retrieve the card from the storage area. When the teacher has the biometric storage device 82, the teacher proceeds B to the biometric device 84, which would be preferably located in a convenient position within the classroom environment 81. The teacher then would insert the card or token 82 into the biometric device 84 and provide a live biometric, such as a fingerprint, for reading by biometric device 84. Biometric device 84 would then compare the stored biometric data to the live biometric data to verify the identity of the teacher. The reverse process would occur at the end of a day. The identity of the teacher as well as the time of the teacher's arrival (and exit) to and from the classroom is biometrically verified and such data may be used for payroll purposes such as overtime, vacation calculations, or other suitable purpose.

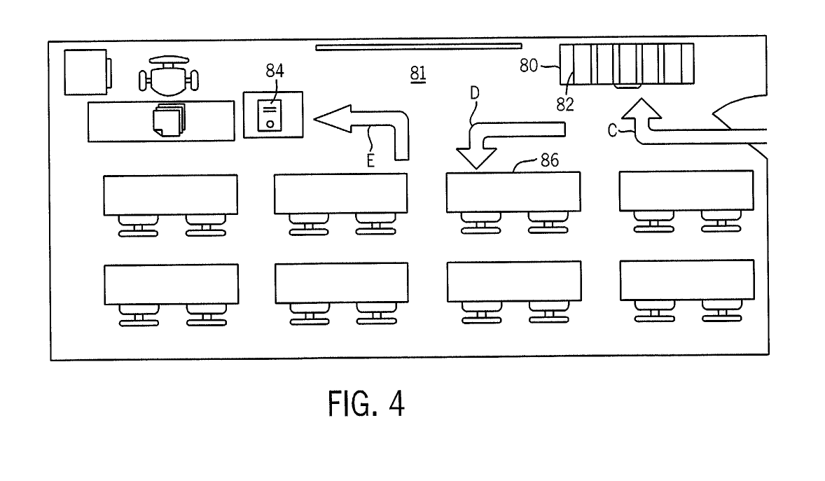

Referring now to FIG. 4, a related application includes the students entering C the representative classroom environment 81. In a similar manner as the instructor, the students arrive at the classroom and approaches storage area 80, and remove their individual biometric data storage devices or tokens 82 having their specific biometric information stored thereon. The students then proceed D to take their seats at their desks 86 as normal. At an appropriate time, for example when attendance is called or prior to the start of class, the students each would proceed E to the biometric device 84, and insert the card or token 82 into the biometric device 84 and provide a live biometric, such as a fingerprint, for reading by biometric device 84. Biometric device 84 would then compare the stored biometric data to the live biometric data to verify the identity of the student. The process could be repeated at the end of a class period. The identity of the student as well as the time of the student's arrival (and exit) to and from the classroom is biometrically verified and such data may be used for student attendance and state reporting purposes, for example. The students may keep their cards or tokens 82 with them or return them to the storage area 80 at the end of a class period or day.

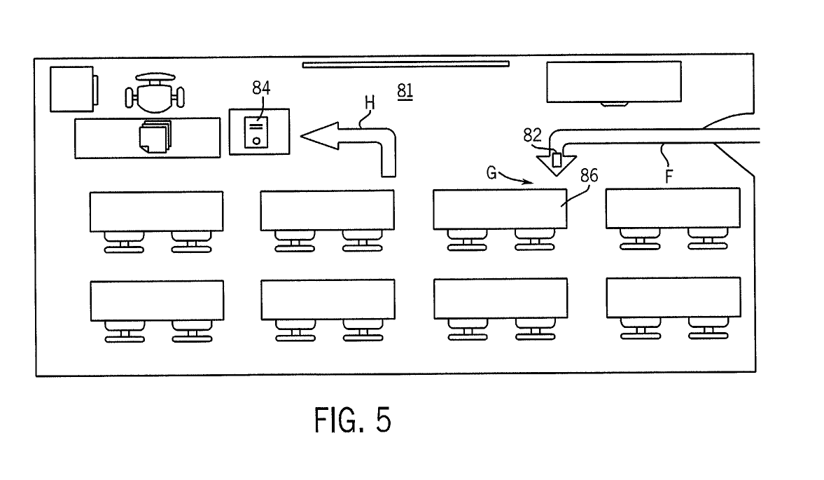

Referring now to FIG. 5, as the students continue their day, and therefore, travel to more than one classroom setting, students from previous classes enter F representative classroom environment 81 with cards 82 from their first period of the day. In a similar manner as before, the students proceed G to take their seats at their desks 86 as normal. At an appropriate time, the students each would proceed H to the biometric device 84, and insert the card or token 82 into the biometric device 84 and provide a live biometric, such as a fingerprint, for reading by biometric device 84. As before, biometric device 84 would then compare the stored biometric data to the live biometric data to verify the identity of the student. This process continues throughout the day such that the identity and attendance of the student, as well as the time of the student's arrival (and exit) to and from each classroom, is biometrically verified. This process may take on many variations depending upon the specific needs of the classroom environment, and the age of the students.

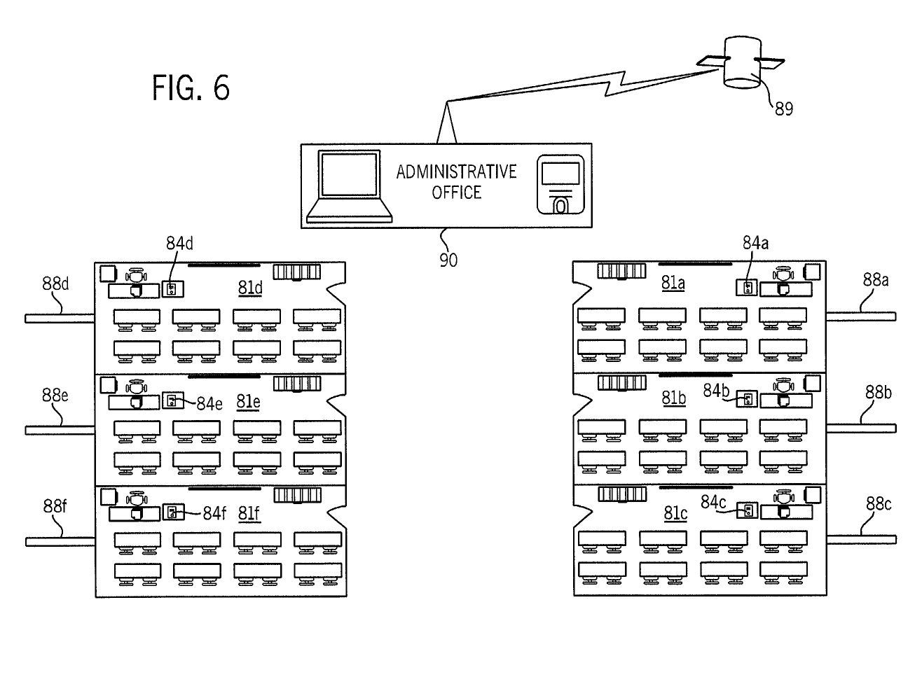

Referring now to FIG. 6, an overview of an exemplary school monitoring system is disclosed. Each of the classrooms 81a-f is capable of transmitting the biometric verified time and attendance data from biometric devices 81a-f via their respective transmittal line 88a-f, which may be a wired connection or wireless, as by a satellite 89 or radio frequency. The time and attendance data is then transmitted to a central administrative office 90, where the time and attendance data for the students and teachers for a particular school may be stored and processed. The model of biometric time and attendance data collection and sending may be repeated and extended out for a school district, a region, and even a state.

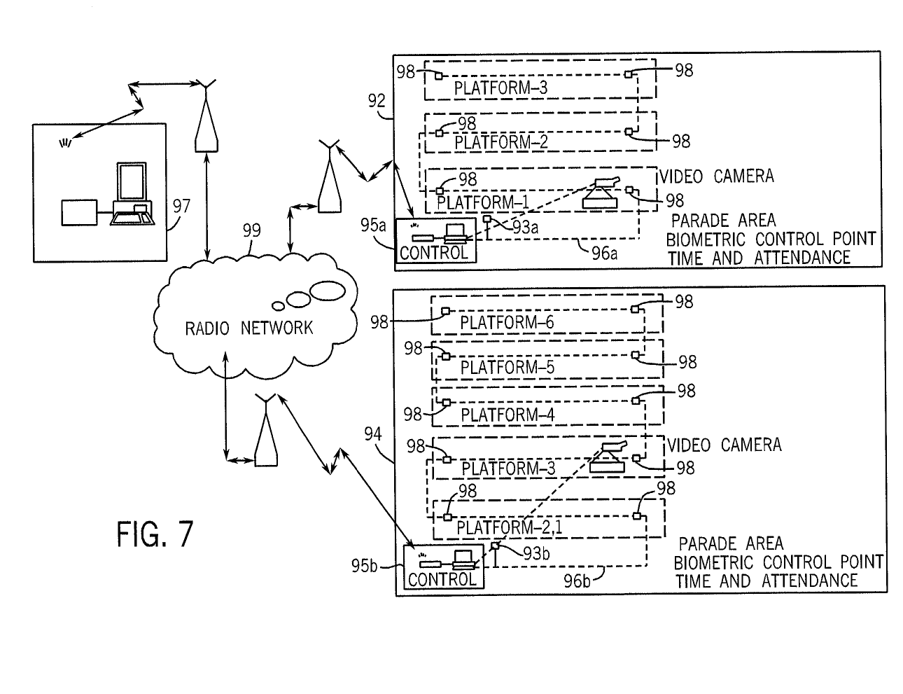

Referring now to FIG. 7, another example of a system using the present invention is shown. This application relates to a parade route example where time and attendance is taken at the starting points as well as at particular points along the parade routes for two separate locations. Each area 92 and 94 has a biometric device 93a-b at an initial control area 95a-b, where initial time and attendance data may be taken. Routes 96a-b are divided up into platforms, and each platform has a pair of biometric devices 98 connected electronically to the control areas 95a-b to mark when an individual passes a particular platform point along each route. The individuals would provide live biometric data such as fingerprints at the biometric devices 98 along the routes and compare them to stored biometric data. The time and attendance data would be transmitted via a radio network 99 to a central data center 97 to provide accurate time and place information for particular individuals it is desired to verify along the routes.

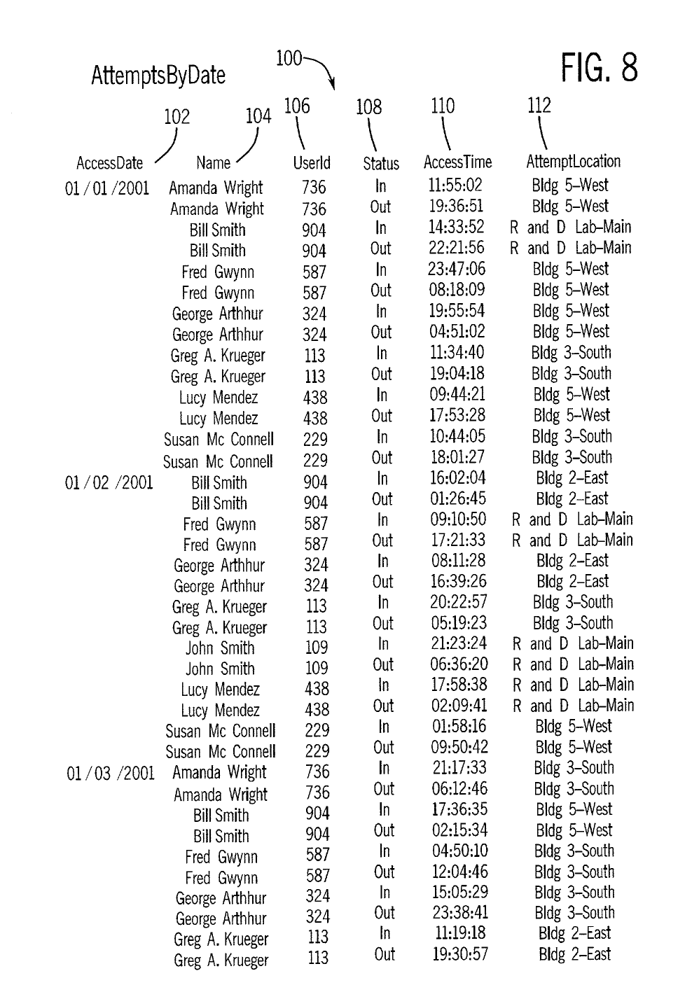

Referring now to FIG. 8, an example of a generated report (76 of FIG. 2) having biometrically verified time and attendance data is shown. By biometrically verified it is meant that the user made a live comparison of a biometric (for example a fingerprint) with stored biometric data to make a positive identification. Such reports can be used in payroll and accounting applications, workplace attendance, security monitors, educational settings and other applications that can take advantage of the precise time and identification features that such systems using biometric devices has. As is shown, the reports may include a variety of configurations as desired, and the present example shows the time and attendance data for a particular date for a variety of biometric devices or locations. The report 100 shows access dates 102, biometrically verified individual names 104 and associated user id numbers 106. In this example it was possible to determine whether the person was entering or exiting 108, and the time 110 of that access. Finally, the location 112 of the biometric time and attendance verification is displayed. The report includes at least a portion of data that has been generated by the biometric devices, and therefore has been biometrically verified, as by fingerprints, for example. Therefore, the reports may be said to have biometric-verified time and attendance data. Preferably, the timing data is derived from a comparison of live biometric data to stored biometric data, and the identification (attendance) data is also derived from the comparison of live biometric data to stored biometric data. It is from this biometric-verified data that the applications derive their value in providing a biometric time/attendance solution

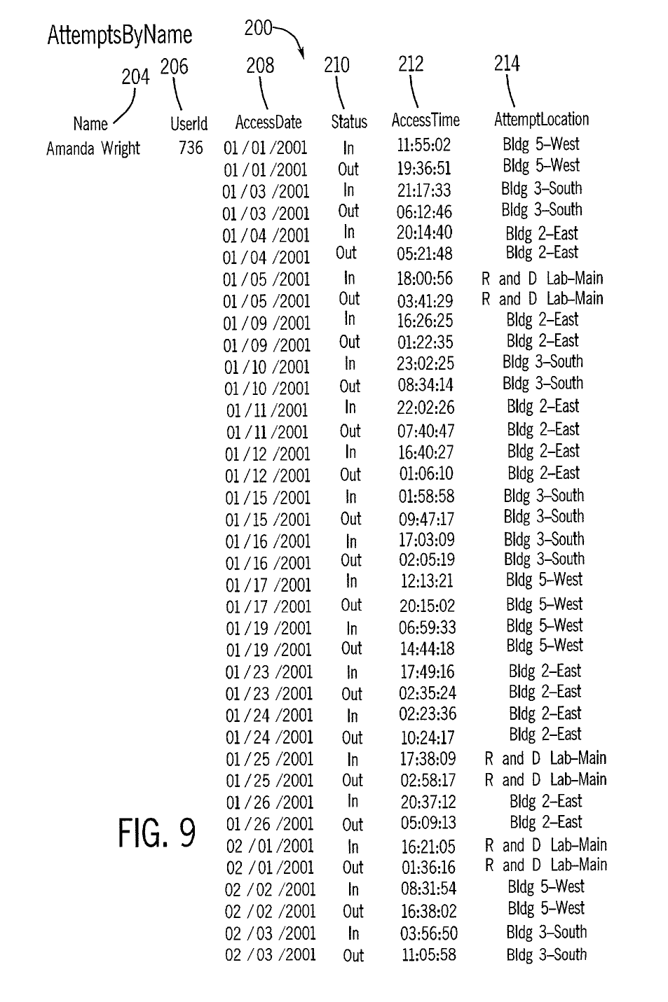

Referring now to FIG. 9, another example of a generated report 200 having biometrically verified time and attendance data is shown. In this example, the report 200 is performed by individual to illustrate the particular time and attendance data for a given individual, such as an employee. The person may also be a student, a teacher, an authorized custodian or any other user of the time and attendance application. In this report 200, the individual of interest is shown with the logging history. The biometrically verified individual names 204 and associated user id numbers 206 are shown. The history of biometric verifications by date 208 is also included. In this example it was possible to determine whether the person was entering or exiting 210, and the time 212 of that access. Finally, the location 214 of the biometric time and attendance verification is displayed. The reports show the use of the biometric devices as biometric time clocks, as well as accurate attendance markers.

Many other types and formats of reports incorporating the biometrically generated time and attendance data may be selected to provide the data gatherer with accurate information as part of the biometric solution.

A method of monitoring time and attendance of a user is disclosed, and includes providing a plurality of biometric devices, each device at a particular location, and biometrically identifying a user. The method includes generating data relating to the user, receiving data from the biometric devices, and processing the data. The data preferably includes information related to the attendance of the user at the particular location during the identifying step. The data also may include information related to a time stamp of when the identifying of the user occurs at the particular location. In a preferred embodiment, the method includes generating a report using the data relating to the user. The biometrically identifying step preferably includes comparing stored biometric data to live biometric data. The receiving of data from the biometric devices may occur periodically or in real time.

The present invention provides several benefits, including significantly increased productivity, accurate attendance information, increased attendance, reduced administrative costs, reduced fraud, and easily generated biometric-verified reports.

The present invention has been described in terms of the preferred embodiment, and it is recognized that equivalents, alternatives, and modifications, aside from those expressly stated, are possible and within the scope of the appending claims.

1. A biometric system comprising:
at least one biometric device capable of identifying a user and generating data related to the user;
a central data center in communication with the at least one biometric device for receiving the generated data; and
wherein the generated data relates to time and attendance information with respect to the user.

2. The biometric system of claim 1 wherein the time and attendance information includes at least one of the group consisting of a user name, a location, an entrance time, an exit time, a check-in time and a time stamp.

3. The biometric system of claim 1 wherein the central data center is in communication to the biometric device via one of a serial connection, a wireless connection, a modem, an ethernet connection and an Internet connection.

4. The biometric system of claim 1 wherein the biometric device compares stored biometric data to live biometric data.

5. The biometric system of claim 4 wherein the stored biometric data and live biometric data are fingerprint data.

6. The biometric system of claim 4 wherein the stored biometric data is stored on one of an optical card, data card, memory card, smart card, biometric token, or storage button.

7. The biometric system of claim 1 wherein the biometric device is used as part of a telephone.

8. The biometric system of claim 1 wherein the biometric device is used as part of a personal digital assistant.

9. The biometric system of claim 1 wherein the biometric device includes a biometric authentication device with a button for fingerprint data storage.

10. The biometric system of claim 1 wherein the biometric device is a biometric authentication device with a wireless data card.

11. The biometric system of claim 1 wherein the biometric device is a laptop computer.

12. The biometric system of claim 1 wherein the biometric device is part of a time clock.

13. A biometric network for use in time and attendance applications comprising:
at least one biometric unit that compares live biometric data with stored biometric data to generate time and attendance data;
a central data center in communication with the biometric device; and
software programmed into the biometric device and operational with the central data center to facilitate communication between the biometric device and the central data center.

14. The network of claim 13 wherein the software includes a configuration module for describing the configuration of the biometric network.

15. The network of claim 14 wherein the configuration module stores information related to the configuration of the biometric network in a biometric network description data store.

16. The biometric system of claim 13 wherein the software further includes an acquisition module programmed to capture transactional data from the biometric network.

17. The biometric system of claim 16 wherein the acquisition module is programmed to send information related to the transactional data into a transactional history data store in the central data center.

18. The biometric system of claim 13 wherein the software further includes an employee data maintenance module programmed to enter and edit employee information from the biometric network.

19. The biometric system of claim 18 wherein the employee data maintenance module is programmed to send employee information into an employee information data store in the central data center.

20. The biometric system of claim 18 wherein the employee data maintenance module is programmed to send employee information into an audit log data store in the central data center.

21. The biometric system of claim 13 wherein the software further includes a company data maintenance module program to enter and edit company data information.

22. The biometric system of claim 21 wherein the company data maintenance module is programmed to send the company data information into a company information data store in the central data center.

23. The biometric system of claim 21 wherein the company data maintenance module is programmed to send the company data information into an audit log data store in the central data center.

24. The biometric system of claim 13 wherein the software includes a manual transaction module programmed to enter manual changes to entries in a transaction history.

25. The biometric system of claim 24 wherein the manual transaction module is programmed to store data related to the manual entries in an audit log data store in the central data center.

26. The biometric system of claim 24 wherein the manual transaction module is programmed to send data related to the manual entries to a transaction history data store in the central data center.

27. The biometric system of claim 13 wherein the software includes a report generation module programmed to permit generation of reports based on the time and attendance data.

28. The biometric system of claim 27 wherein the reports include information gathered from at least one of a biometric network description data store, a transaction history data store, an employee information data store, a company information data store, an audit log data store, a transaction history data store, and a biometric network diagnostic log data store.

29. A biometric system comprising:
at least one biometric device for comparing live biometric data to stored biometric data and generating time and attendance data based on the comparison; and
a central data center in communication with the biometric device for receiving the time and attendance data from the biometric device.

30. The biometric system of claim 29 wherein the data is selected from the group consisting of user entry time, user exit time, user check-in time and user attendance.

31. A fingerprint system comprising:
at least one fingerprint device for comparing live fingerprint data to stored fingerprint data and generating time and attendance data based on the comparison; and
a central data center in communication with the fingerprint device for receiving the time and attendance data from the fingerprint device.

32. The system of claim 31 wherein the data is selected from the group consisting of user entry time, user exit time, user check-in time and user attendance.

33. The system of claim 29 further including a report including at least a portion of the time and attendance data generated by the biometric device.

34. The system of claim 31 further including a report including at least a portion of the time and attendance data generated by the fingerprint device.

35. A time and attendance network for use in an educational setting comprising:
a plurality of biometric tokens, each biometric token having stored biometric data thereon specific to a user;
at least one biometric device, the biometric device capable of comparing user live biometric data with the stored biometric data on the biometric token and generating data related to the user;
wherein each biometric device is in communication with a central data center to receive and process the data.

36. The time and attendance network of claim 35 wherein the data is selected from the group consisting of user entry time, user exit time, user check-in time and user attendance.

37. The time and attendance network of claim 35 wherein the user is a student.

38. The time and attendance network of claim 35 wherein the user is a teacher.

39. The time and attendance network of claim 35 wherein the user is an authorized student guardian.

40. A classroom time and attendance network comprising:
at least one biometric device in a classroom capable of capable of biometrically identifying a user and generating data related to the user;
a central data center in communication with the at least one biometric device for receiving the generated data; and
wherein the generated data relates to time and attendance information with respect to the user.

41. The network of claim 40 wherein the data is selected from the group consisting of user entry time, user exit time, user check-in time and user attendance.

42. A report for use in time and attendance applications comprising:
timing data derived from a comparison of live biometric data to stored biometric data; and
identification data derived from the comparison of live biometric data to stored biometric data.

43. A report for use in time and attendance applications comprising:
timing data derived from a comparison of live fingerprint data to stored fingerprint data; and
identification data derived from the comparison of live fingerprint data to stored fingerprint data.

44. A report for use with a biometric device comprising:
timing data; and
identification data related to the timing data;
wherein at least a portion of the timing data and the identification data are generated by the biometric device as a result of a biometric verification.

45. A report for use with a fingerprint device comprising:
timing data; and
identification data related to the timing data;
wherein at least a portion of the timing data and the identification data are generated by the fingerprint device as a result of a fingerprint verification.

46. A report for use with a biometric device comprising:
at least one data type selected from the group consisting of entrance time, exit time, name, check-in time, check-out time, user identification, and payroll number;
wherein at least a portion of the data is generated by the biometric device as a result of a biometric verification.

47. The report of claim 46 wherein the biometric verification generating at least a portion of the data includes fingerprint verification.

48. The report of claim 46 wherein the data is derived from a comparison of live biometric data to stored biometric data at the biometric device.

49. A method of biometric time and attendance reporting comprising:
providing at least one biometric device;
with the biometric device, comparing live biometric data with stored biometric data to generate time and attendance data; and
communicating the time and attendance data to a central data center in communication with the at least one biometric device.

50. The method of claim 49 wherein the method further comprises generating a report using the time and attendance data.

51. The method of claim 49 wherein the live and stored biometric data are fingerprint data.

52. A method of biometric time and attendance reporting comprising:
providing at least one biometric device;
biometrically identifying a user and generating data related to the user;
communicating the data to a central data center in communication with the at least one biometric device.

53. The method of claim 52 wherein the user is one selected from the group consisting of a student, teacher, professor, authorized child custodian, parent, therapist or school-related personnel.

54. The method of claim 52 wherein the biometrically identifying step includes taking fingerprint data from the user.

55. A method of monitoring time and attendance activities comprising:
providing a plurality of biometric devices, each device at a particular location;
biometrically identifying a user and generating data relating to the user;
receiving data from the biometric devices; and
processing the data;
wherein the data includes information related to the attendance of the user at the particular location.

56. The method of claim 55 wherein the data includes information related to when the identifying of the user occurs at the particular location.

57. The method of claim 55 wherein the method further comprises generating a report using the data relating to the user.

58. The method of claim 55 wherein the method further comprises comparing stored biometric data to live biometric data.

59. The method of claim 55 wherein the method further includes receiving the data from the biometric devices periodically.

60. The method of claim 55 wherein the receiving of the data from the biometric devices occurs in real time.
